(19) United States
(12) Patent Application Publication
(10) Pub. No.: US 2009/0206738 A1
(43) Pub. Date: Aug. 20, 2009

(54) ORGANIC LIGHT-EMITTING DIODE DISPLAY DEVICE AND METHOD OF MANUFACTURING THE SAME

(75) Inventors: Won-Hoe KOO, Suwon-si (KR); Joo-Hyeon LEE, Yongin-si (KR); Chang-Woong CHU, Suwon-si (KR); Chang-Mo PARK, Seoul (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/336,915

(22) Filed: Dec. 17, 2008

(30) Foreign Application Priority Data
Feb. 18, 2008 (KR) 2008-14312

(51) Int. Cl. H01J 1/62; H01J 9/24; H01J 9/26

(52) U.S. Cl. 313/504; 445/24; 445/25

(57) ABSTRACT

An organic light-emitting diode (“OLED”) display device includes; an organic light-emitting substrate part including a base substrate including; a display region and a peripheral region substantially surrounding the display region, and an OLED display portion disposed in the display region, and a protective cover part including; a cover substrate facing the base substrate, a cover frit glass disposed on a face of the cover substrate and contacting and substantially covering the OLED display portion, and a sealing frit glass disposed on the face of the cover substrate in the peripheral region and combining the base substrate and the cover substrate with each other.

This application claims priority to Korean Patent Application No. 2008-14312 filed on Feb. 18, 2008 and all the benefits accruing therefrom under 35 U.S.C. §119, the contents of which in its entirety are herein incorporated by reference.

### BACKGROUND OF THE INVENTION

1. Field of the Invention

The present invention relates to a display device and a method of manufacturing the display device. More particularly, the present invention relates to an organic light-emitting diode (“OLED”) display device having OLEDs, and a method of manufacturing the OLED device.

2. Description of the Related Art

Generally, an organic light-emitting diode (“OLED”) display device includes a base substrate, an OLED display portion formed on a face of the base substrate to display images and a cover substrate disposed to face the base substrate.

The OLED display portion includes a plurality of unit pixels for displaying images, and each of the unit pixels includes an OLED displaying color. Generally, the OLED display portion may be easily damaged from external moisture or external impacts.

In order to protect the OLED display portion from external moisture the base substrate and the cover substrate are sealed using sealing frit glass. In detail, the sealing frit glass formed along edges of the cover substrate glass is combined with the base substrate to protect the OLED display portion from the external moisture.

When the OLED device increases in size, the base substrate and the cover substrate also increase in size. When the cover substrate increases in size, the cover substrate may sag toward the OLED display portion due to the weight of the cover substrate.

When the cover substrate sags toward the OLED display portion, the cover substrate may repeatedly make contact with the OLED display portion. As a consequence, the cover substrate may transfer impacts to the OLED display portion. Impacts to the cover substrate to the OLED display portion may damage the OLED display portion and result in a lower display quality.

### BRIEF SUMMARY OF THE INVENTION

The present invention provides an organic light-emitting diode (“OLED”) display device capable of reducing the effects of impacts to the cover substrate to enhance display quality.

The present invention also provides a method of manufacturing the OLED device.

In one exemplary embodiment of the present invention, an OLED device includes; a base substrate including a display region and a peripheral region substantially surrounding the display region, and an OLED display portion disposed in the display region and configured to display images, and a protective cover part including; a cover substrate facing the base substrate, a cover frit glass disposed on a face of the cover substrate and contacting and substantially covering the OLED display portion, and a sealing frit glass disposed on the face of the cover substrate in the peripheral region and combining the base substrate and the cover substrate with each other.

In one exemplary embodiment, the cover frit glass may include a plurality of frit powder particles combined with each other. In one exemplary embodiment, the cover frit glass may be in a substantially porous state.

In one exemplary embodiment, the sealing frit glass may have lower water reactivity than the cover frit glass. In one exemplary embodiment, the sealing frit glass may have a lower thermal expansion coefficient than the cover frit glass. In one exemplary embodiment, the thermal expansion coefficient of the sealing frit glass may be substantially the same as the thermal expansion coefficient of at least one of the cover substrate and the base substrate. In one exemplary embodiment, the sealing frit glass may include; a plurality of frit powder particles combined with each other, and a plurality of filler particles interposed between and combining the frit powder particles.

According to another exemplary embodiment of the present invention, an exemplary embodiment of a method of manufacturing an OLED display device includes; providing an organic light-emitting substrate part including a base substrate having a display region and a peripheral region substantially surrounding the display region, and an OLED display portion disposed in the display region, providing a protective cover part including a cover substrate, a cover frit glass disposed on a face of the cover substrate, and a sealing frit glass disposed on the face of the cover substrate and substantially surrounding an outer edge of the cover frit glass, and combining the organic light-emitting substrate part and the protective cover part with each other such that the cover frit glass makes contact with the OLED display portion and covers the OLED display portion.

In one exemplary embodiment, the providing the protective cover part includes; disposing a cover frit paste having viscosity on the face of the cover substrate, forming the cover frit glass through drying and firing of the cover frit paste, disposing a sealing frit paste having viscosity on a face of the cover substrate and substantially surrounding an outer edge of the cover frit glass, and forming the sealing frit glass through drying and firing the sealing frit paste.

In one exemplary embodiment, the cover frit paste may include; a plurality of frit powder particles, a plurality of binder particles interposed between the frit powder particles, and solvent which dissolves the frit powder particles and the binder particles.

In one exemplary embodiment, the forming of the cover frit glass comprises; removing the solvent by drying the cover frit paste at a first temperature, and firing the cover frit paste at a second temperature higher than the first temperature. In one exemplary embodiment, the first temperature may be in a range of about 180° C. to about 220° C., and the second temperature may be in a range of about 300° C. to about 600° C.

In one exemplary embodiment, the sealing frit paste may include; a plurality of frit powder particles, a plurality of binder particles interposed between the frit powder particles, a plurality of filler particles interposed between the frit powder particles, and solvent which dissolves the frit powder particles, the binder particles and the filler particles.

In one exemplary embodiment, the forming of the sealing frit glass includes; removing the solvent by drying the sealing frit paste at a third temperature, and firing the cover frit paste at a fourth temperature higher than the third temperature.

In one exemplary embodiment, the providing of the protective cover part includes disposing a sealing frit paste having viscosity on the face of the cover substrate along edges of the cover substrate, forming the sealing frit glass by drying and firing the sealing frit paste, disposing a cover frit paste having viscosity is disposed on the face of the cover substrate within an area defined by the sealing frit glass, and forming the cover frit glass by drying and firing the cover frit paste.

In one exemplary embodiment, forming the protective cover part includes; disposing a cover frit paste and a sealing frit paste having viscosity on the face of the cover substrate such that the sealing frit paste substantially surrounds the cover frit paste, and forming the cover frit glass and the sealing frit glass by drying and firing the cover frit paste and the sealing frit paste.

In one exemplary embodiment, the combining of the organic light-emitting substrate part and the protective cover part, includes; aligning the organic light-emitting substrate part and the protective cover part with each other such that the cover frit glass contacts the OLED display portion and covers the OLED display portion, and applying a laser beam to the sealing frit glass to combine the base substrate and the cover substrate with each other and to seal a space between the base substrate and the cover substrate.

In another exemplary embodiment, the aligning the organic light-emitting substrate part and the protective cover part further includes; vacuum compressing the organic light-emitting substrate part and the protective cover part.

In one exemplary embodiment, the sealing frit glass may have a lower water reactivity and a lower thermal expansion coefficient than the cover frit glass. In one exemplary embodiment, a melting point of the cover frit glass may be in a range of about 300° C. to 600° C., and a melting point of the sealing frit glass is in a range of about 400° C. to about 500° C.

According to the present invention, the cover frit glass is formed on the face of the cover substrate such that the cover frit glass makes contact with the OLED display portion, and covers the OLED display portion, so that the effects of impacts to the cover substrate on the OLED display portion may be reduced. As a result, display quality of the OLED is improved.

### BRIEF DESCRIPTION OF THE DRAWINGS

The above and other features and advantages of the present invention will become more apparent by describing in detailed exemplary embodiments thereof with reference to the accompanying drawings, in which:

FIG. 1 is a top plan view illustrating an exemplary embodiment of an organic light-emitting diode (“OLED”) display device according to the present invention;

FIG. 2 is a cross-sectional view taken along line I-I′ in FIG. 1;

FIG. 3 is an equivalent circuit diagram illustrating an exemplary embodiment of a unit pixel of the exemplary embodiment of an OLED display of FIG. 1;

FIG. 4 is a cross-sectional view illustrating an exemplary embodiment of a process of forming the exemplary embodiment of an organic light-emitting substrate part in FIG. 2;

FIG. 5 is a cross-sectional view illustrating an exemplary embodiment of a process of forming a cover frit glass on a cover substrate in the exemplary embodiment of an organic light-emitting substrate part in FIG. 2;

FIG. 6 is a magnified view illustrating a portion ‘A’ in FIG. 5;

FIG. 7 is a cross-sectional view illustrating an exemplary embodiment of a process of forming a sealing frit glass on the cover substrate in FIG. 5;

FIGS. 8A and 8B are cross-sectional views illustrating states before and after firing of the sealing frit glass;

FIG. 9 is a cross-sectional view illustrating a process of combination between the exemplary embodiment of an organic light-emitting substrate part of FIG. 4 and the exemplary embodiment of a protective cover part of FIG. 5;

FIG. 10 is a cross-sectional view illustrating an exemplary embodiment of a process of applying a laser beam to the sealing frit glass; and

FIGS. 11A and 11B are cross-sectional views illustrating states before and after applying a laser beam to the sealing frit glass.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Exemplary embodiments of the present invention are described herein with reference to cross-section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

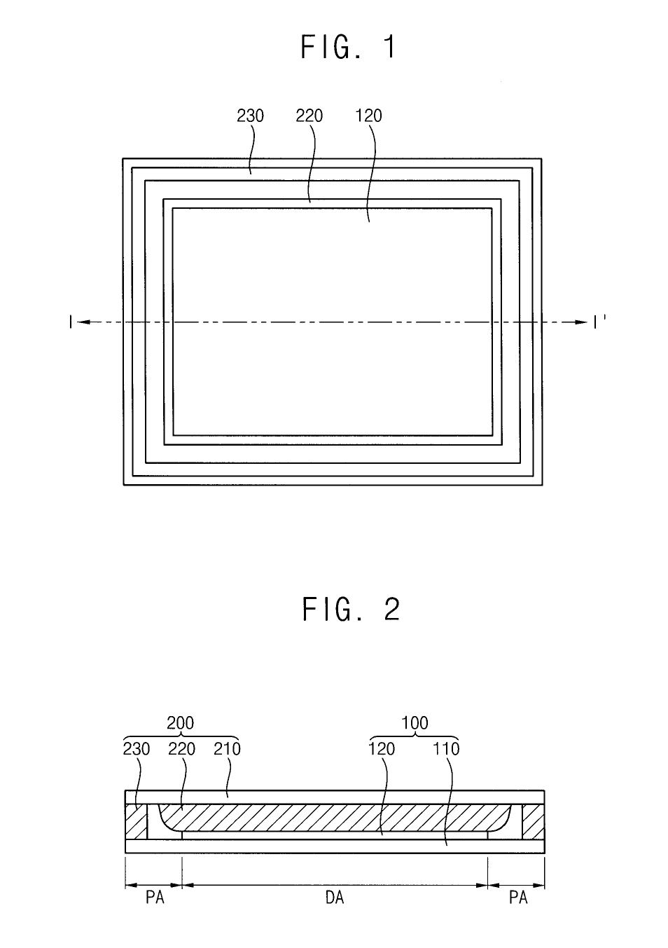

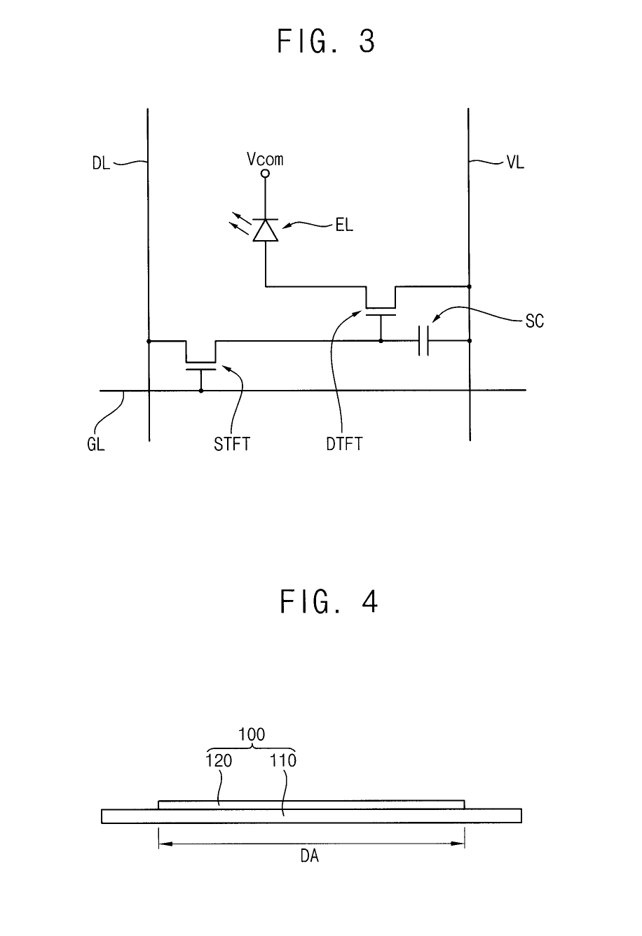

FIG. 1 is a top plan view illustrating an exemplary embodiment of an organic light-emitting diode (“OLED”) display device according to the present invention. FIG. 2 is a cross-sectional view taken along line I-I′ in FIG. 1, and FIG. 3 is an equivalent circuit diagram illustrating an exemplary embodiment of a unit pixel of the exemplary embodiment of an OLED display of FIG. 1.

Referring to FIGS. 1, 2 and 3, an exemplary embodiment of an OLED device according to the present invention includes an organic light-emitting substrate part 100 for displaying images and a protective cover part 200 for protecting the organic light-emitting substrate part 100.

The organic light-emitting substrate part 100 includes a base substrate 110 and an OLED display portion 120 formed on a face of the base substrate 110 to display images.

In the present exemplary embodiment, the base substrate 110 has a plate shape. Exemplary embodiments of the base substrate 110 may include transparent glass, exemplary embodiments of which may include potassium-lime glass, soda-lime glass, quartz glass, and other materials with similar characteristics.

The base substrate 110 includes a display region DA for displaying images and a peripheral region PA surrounding the display region DA. In other words, the peripheral region PA is formed along peripheral edges of the base substrate 110.

The OLED display portion 120 is formed on a face of the base substrate 110 in the display region DA. The OLED display portion 120 includes a plurality of unit pixels (not shown) for displaying images. Each of the unit pixels may include a switching transistor STFT connected to a gate line LG and a data line DL, a driving transistor DTFT connected to the switching transistor STFT, a bias line VL, an OLED EL and a storage capacitor SC. Alternative exemplary embodiments include configurations wherein the unit pixel omits the driving transistor DTFT and the bias line VL.

The gate line GL extends in a first direction, and the data line DL extends in a second direction which is different from the first direction. In one exemplary embodiment, the bias line VL may be formed substantially parallel with the data line DL.

As mentioned above, the switching transistor STFT may be electrically connected to the gate line GL, the data line DL and the driving transistor DTFT. In detail, a gate electrode of the switching transistor STFT may be electrically connected to the gate line GL, a source electrode of the switching transistor STFT may be electrically connected to the data line DL, and a drain electrode of the switching transistor STFT may be electrically connected to the driving transistor DTFT.

The driving transistor DTFT may be electrically connected to the drain electrode of the switching transistor STFT, the bias line VL and the OLED EL. In detail, a gate electrode of the driving transistor DTFT may be electrically connected to the drain electrode of the switching transistor STFT, a source electrode of the driving transistor DTFT may be electrically connected to the bias line VL, and a drain electrode of the driving transistor DTFT may be electrically connected to the OLED EL.

The OLED EL may be electrically connected to the drain electrode of the driving transistor DTFT and a common electrode terminal Vcom. In detail, a first electrode of the OLED EL may be electrically connected to the drain electrode of the driving transistor DTFT, and a second electrode of the OLED EL may be electrically connected to the common electrode terminal Vcom.

The storage capacitor SC may be electrically connected to the gate electrode of the driving transistor DTFT and the bias line VL. In detail, a first electrode of the storage capacitor SC may be electrically connected to the gate electrode of the driving transistor DTFT, and a second electrode of the storage capacitor SC may be electrically connected to the bias line VL.

Alternative exemplary embodiments include configurations wherein the storage capacitor, the driving transistor and the bias line VL may be omitted. In such an alternative exemplary embodiment, the first electrode of the OLED EL may be connected to the drain electrode of the switching transistor STFT.

Hereinafter, an operation of the unit pixel will be explained. When a gate signal is applied to the gate line GL to turn on the switching transistor STFT, a data signal from the data line DL is applied to the gate electrode of the driving transistor DTFT. The data signal is stored in the storage capacitor SC to turn on the driving transistor DTFT for one frame. As a result, a driving current is applied from the bias line VL to the OLED EL for one frame, so that the OLED EL emits light.

Referring again to FIG. 2, the protective cover part 200 includes a cover substrate 210, a cover frit glass 220 formed on a face of the cover substrate 210 and a sealing frit glass 230 formed on the face of the cover substrate 210 outside of the cover frit glass 220.

The cover substrate 210 is disposed such that the cover substrate 210 faces the base substrate 110. In one exemplary embodiment, the cover substrate 210 has a substantially planar shape, and includes transparent glass. In one exemplary embodiment, the cover substrate 210 may include substantially the same material as the base substrate 110. In detail, exemplary embodiments of the cover substrate 210 may include potassium-lime glass, soda-lime glass, quartz glass, and other materials with similar characteristics.

The cover frit glass 220 is formed on the face of the cover substrate 210 such that the cover frit glass 220 corresponds to the display region DA. The cover frit glass 220 makes contact with the OLED display portion 120 to cover the OLED display portion 120. In one exemplary embodiment, a lower portion of the cover frit glass 220, which makes contact with an upper portion of the OLED display portion 120, is substantially flat and smooth. In one exemplary embodiment, the cover frit glass 220 may include a plurality of frit powder particles combined with each other. In one exemplary embodiment, the cover frit glass 220 may be in a porous state.

The sealing frit glass 230 is formed on the face of the cover substrate 210 such that the sealing frit glass 230 corresponds to the peripheral region PA. In one exemplary embodiment, the sealing frit glass 230 is formed along edges of the cover substrate 210 to surround the cover frit glass 220.

The sealing frit glass 230 combines the base substrate 110 and the cover substrate 210 to each other to seal a space between the base substrate 110 and the cover substrate 210. Therefore, the sealing frit glass 230 prevents external moisture from penetrating the OLED display portion 120 and protects the OLED display portion 120.

In one exemplary embodiment, the sealing frit glass 230 may have a width of about 400 μm to about 1,000 μm. In one exemplary embodiment, the sealing frit glass 230 may have a thickness of about 5 μm to about 25 μm. In one exemplary embodiment, the thickness of the cover frit glass 220 may be thinner than that of the sealing frit glass 230. In one exemplary embodiment, the sealing frit glass 230 may absorb a laser beam having a wavelength of about 800 nm to about 820 nm.

In one exemplary embodiment, the sealing frit glass 230 may have lower water reactivity than that of the cover frit glass 220 in order to prevent moisture penetration into the space SP. In one exemplary embodiment, the sealing frit glass 230 may have a lower thermal expansion coefficient than the cover frit glass 220, and in particular, the sealing frit glass 230 may have the same thermal expansion coefficient as the cover substrate 210 and/or the base substrate 110.

In the exemplary embodiment wherein the sealing frit glass 230 has a lower thermal expansion coefficient than the cover frit glass 220, or when the sealing frit glass 230 has substantially the same thermal expansion coefficient as that of the cover substrate 210 or the base substrate 110, cracks in the sealing frit glass 230, which is induced by thermal expansion of the sealing frit glass 230, may be prevented.

In one exemplary embodiment, the sealing frit glass 230 may include a plurality of frit powder particles combined with each other, and a plurality of filler particles disposed between the frit powder particles. In one exemplary embodiment, the ratio of weight percent of the filler particles to the entire weight of the sealing frit glass 230 may be in a range of about 10% to about 30%.

In one exemplary embodiment, the filler particles may be interpositioned between the frit powder particles to lower the water reactivity of the sealing frit glass 230 or the thermal expansion coefficient of the sealing frit glass 230. In one exemplary embodiment, the filler particles may be in a crystal state, e.g., the filler particles may include eucryptite crystal, cordierite crystal, lepidolite crystal, spodumene crystal, or other materials with similar characteristics.

In one exemplary embodiment, each of the frit powder particles of the cover frit glass 220 may include vanadium oxide (“V₂O₅”), phosphorus oxide (“P₂O₅”), or other materials with similar characteristics. In one exemplary embodiment, the frit powder includes about 20% to about 45% of vanadium oxide (“V₂O₅”), and about 20% to about 30% phosphorus oxide (“P₂O₅”). In one exemplary embodiment, the frit powder of the cover frit glass 220 may further include zinc oxide (“ZnO”), bismuth oxide (“Bi₂O₃”), boron trioxide (“B₂O₃”), iron oxide (“Fe₂O₃”), aluminum oxide (“Al₂O₃”), silicon dioxide (“SiO₂”), and other materials with similar characteristics.

The cover frit glass 220 may further include a first oxide which may enhance adhesive strength of the frit powder, and a second oxide which may stabilize glass. For example, exemplary embodiments of the first oxide may include lithium oxide (“Li₂O”), sodium oxide (“Na₂O”), potassium oxide (“K₂O”), cesium oxide (“Cs₂O”), and other materials with similar characteristics, and examples of the second oxide may include magnesium oxide (“MgO”), calcium oxide (“CaO”), strontium oxide (“SrO”), barium oxide (“BaO”), and other materials with similar characteristics.

In one exemplary embodiment, the frit powder of the sealing frit glass 230 may include substantially the same elements described above, similar to the frit powder of the cover frit glass 220.

The inclusion of Phosphorus oxide (“P₂O₅”) into the cover frit glass 220 lowers the melting point of the cover frit glass 220 but enhances the water reactivity of the cover frit glass 220. Therefore, in one exemplary embodiment, the frit powder of the sealing frit glass 230 may exclude phosphorus oxide (“P₂O₅”), or include a relatively small amount of phosphorus oxide (“P₂O₅”) when compared with the frit powder of the cover frit glass 220.

As described above, the sealing frit glass 230 may include various elements and various component ratios thereof in order to result in a sealing frit glass 230 having low water reactivity and a low melting point. However, the cover frit glass 220 may include various elements and various component ratios thereof without having the limitations of low water reactivity and a low melting point. In one exemplary embodiment, the sealing frit glass 230 may have a melting point of about 400° C. to about 500° C., and the cover frit glass 220 may have a melting point of about 300° C. to about 600° C.

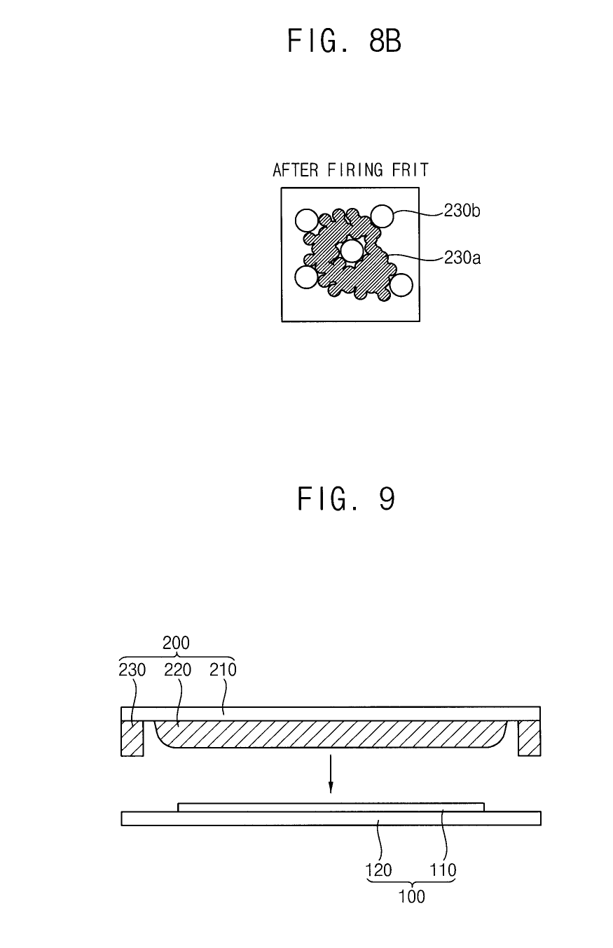

The structure and an exemplary embodiment of manufacturing the cover and sealing frit glass 220 and 230, respectively, will be discussed in more detail with respect to FIGS. 8A and 8B.

Hereinafter, an exemplary embodiment of a method of manufacturing the exemplary embodiment of an OLED device will be discussed in detail.

FIG. 4 is a cross-sectional view illustrating an exemplary embodiment of a process of forming the exemplary embodiment of an organic light-emitting substrate part in FIG. 2.

Referring to FIG. 4, the OLED display portion 120 is formed on a face of the base substrate 110 in the display region DA. The OLED display portion 120 may include a plurality of layers formed through various deposition processes and etching processes.

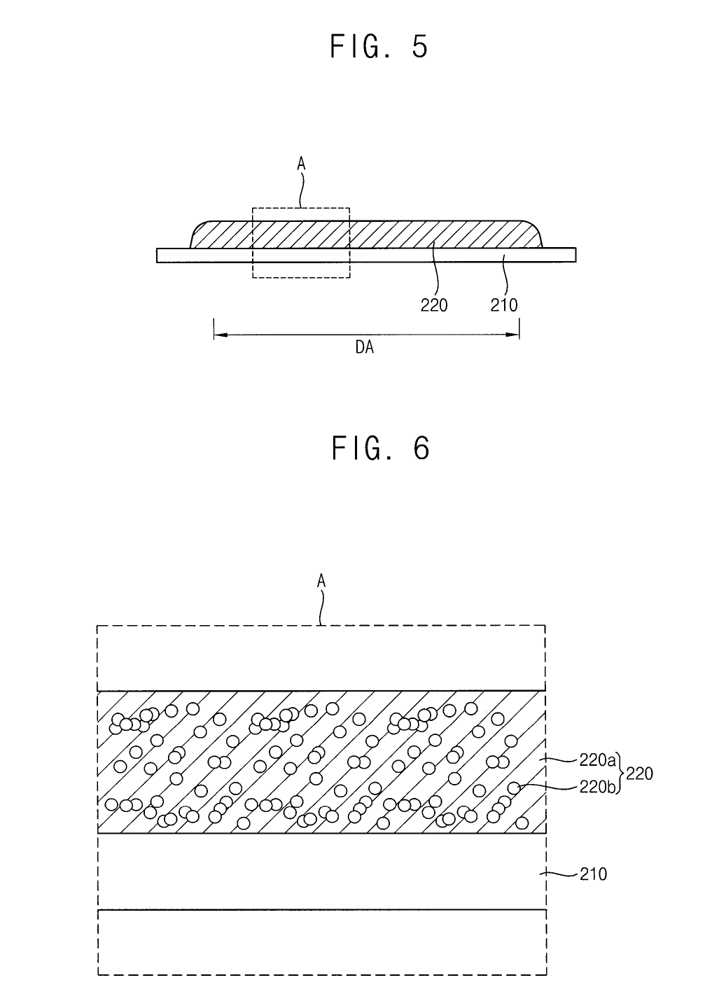

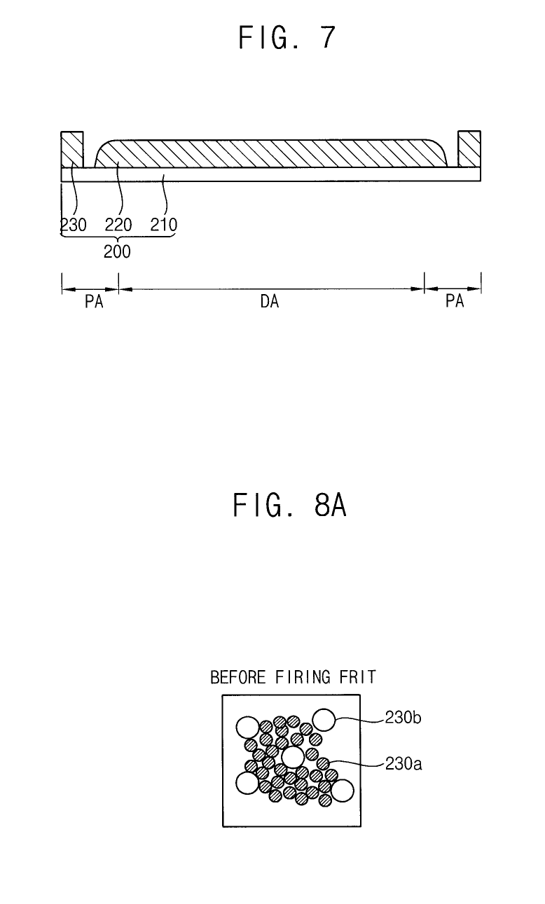

FIG. 5 is a cross-sectional view illustrating an exemplary embodiment of a process of forming a cover frit glass 220 on a cover substrate 210 in the exemplary embodiment of an organic light-emitting substrate part in FIG. 2, and FIG. 6 is a magnified view illustrating a portion ‘A’ in FIG. 5.

Referring to FIG. 5, the cover frit glass 220 is formed on a face of the cover substrate 210 in the display region DA.

In one exemplary embodiment, in order to form the cover frit glass 220, a cover frit paste (not shown) having a viscosity is disposed on the face of the cover substrate 210, and then the cover frit paste undergoes drying and firing to form the cover frit glass 220. In one exemplary embodiment, the cover frit paste is disposed on the face of the cover substrate 210 to correspond to the display region DA. Exemplary embodiments include configurations wherein the cover frit paste may be sprayed onto the cover substrate 210 by a spray unit (not shown), or disposed through a silk screen method or formed by various other methods as known in the art. The cover frit paste may include a plurality of frit powder particles, the binder particles interposed between the frit powder particles, and solvent dissolving the frit powder particles and the binder particles.

In one exemplary embodiment, when the cover frit paste is disposed on the face of the cover substrate 210, the cover frit paste may be heated under the condition of a first temperature to remove the solvent. In one exemplary embodiment, the first temperature may be in a range of about 180° C. to about 220° C., and in particular, in one exemplary embodiment, the first temperature may be about 200° C.

Then, the cover frit paste, with the solvent substantially removed, undergoes firing under the condition of a second temperature, which may be higher than the first temperature, to remove the binder particles. The second temperature may be in a range of about 300° C. to about 600° C., and in particular, in one exemplary embodiment, the second temperature may be about 450° C. The surface of the cover frit paste may be treated to be flat and smooth through the firing process.

Referring to FIG. 6, when the cover frit paste is heated under the condition of the first temperature to remove the solvent, and undergoes the firing under the second temperature to remove the binder particles, the cover frit paste becomes the cover frit glass 220 in a substantially porous state. It is preferable that inner particles of the cover frit glass 220 are not in a crystal state through the heating and firing. As can be seen in FIG. 6, the cover frit glass 220 includes a solid material 220a and voids 220b in the solid material 220a left by the removal of the binder material.

FIG. 7 is a cross-sectional view illustrating an exemplary embodiment of a process of forming a sealing frit glass 230 on the cover substrate 210 in FIG. 5, and FIGS. 8A and 8B are cross-sectional views illustrating states before and after firing of the sealing frit glass 230.

Referring to FIG. 7, the sealing frit glass 230 is formed on the face of the cover substrate 210 in the peripheral region PA. In one exemplary embodiment, the sealing frit glass 220 is formed after the cover frit glass 220.

In order to form the sealing frit glass 230, a sealing frit paste (not shown) is disposed on the face of the cover substrate 210 along outside edges of the cover frit glass 220, and then the sealing frit paste undergoes drying and firing to form the sealing frit glass 230.

In one exemplary embodiment, the sealing frit paste is disposed on the face of the cover substrate 210 to correspond to the peripheral region PA. Exemplary embodiments include configurations wherein the sealing frit paste may be sprayed by a spray unit (not shown), or disposed through a silk screen method, or formed through various other methods as known in the art.

In one exemplary embodiment, the sealing frit paste may include a plurality of frit powder particles 230a, a plurality of binder particles (not shown) interposed between the frit powder particles 230a, a plurality of filler particles 230b interposed between the frit powder particles 230a, and a solvent dissolving the frit powder particles 230a, the binder particles and the filler particles 230b.

When the sealing frit paste is disposed on the face of the cover substrate 210, the sealing frit paste is heated under the condition of a third temperature to remove the solvent. In one exemplary embodiment, the third temperature may be substantially the same as the first temperature, e.g., the third temperature may be in a range of about 180° C. to about 220° C. and more particularly, in one exemplary embodiment, the third temperature may be about 200° C.

Then, the sealing frit paste with the solvent substantially removed undergoes firing under the condition of a fourth temperature higher than the third temperature to remove the binder particles. In one exemplary embodiment, the fourth temperature may be substantially the same as the second temperature. In one exemplary embodiment, the fourth temperature may be in a range of about 300° C. to about 600° C., and more particularly, in one exemplary embodiment, the fourth temperature may be about 450° C.

Referring to FIGS. 8A and 8B, the sealing frit paste may be heated under the condition of the third temperature to remove the solvent, and may undergo firing under the fourth temperature to remove the binder particles. The sealing frit paste then becomes the sealing frit glass 230 in which the frit powder particles 230a are combined with each other by the filler particles 230b.

Even when the solvent and the binder particles are removed from the sealing frit paste to form the sealing frit glass 230 through the drying and the firing, the sealing frit glass 230 is not in a porous state since the frit powder particles 230a are strongly combined with each other by the filler particles 230b. Therefore, the melting point of the sealing frit glass 230 may be, in general, higher than the melting point of than the cover frit glass 220. In one exemplary embodiment, inner particles of the sealing frit glass 230 are not in a crystal state through the heating and firing processes.

In one exemplary embodiment, the sealing frit glass 230 may have a width of about 400 μm to about 1,000 μm, and the sealing frit glass 230 may have a thickness of about 5 μm to about 25 μm. In one exemplary embodiment, the thickness of the sealing frit glass 230 is thicker than the thickness of the cover frit glass 220, e.g., in one exemplary embodiment, the thickness of the sealing frit glass 230 may be thicker than the thickness of the cover frit glass 220 by a thickness substantially equal to a thickness of the OLED display portion 220 of FIG. 4.

In the current exemplary embodiment, the cover frit paste undergoes drying and firing to form the cover frit glass 220 firstly, and then the sealing frit paste undergoes drying and firing to form the sealing frit glass 230. However, alternative exemplary embodiments include configurations wherein the sealing frit paste may undergo drying and firing to form the sealing frit glass 230 firstly, and then the cover frit paste may undergo drying and firing to form the cover frit glass 220. Furthermore, in another alternative exemplar embodiment, the sealing frit paste and the cover frit paste may be formed on the face of the cover substrate firstly, and then the sealing frit paste and the cover frit paste may undergo drying and firing substantially simultaneously.

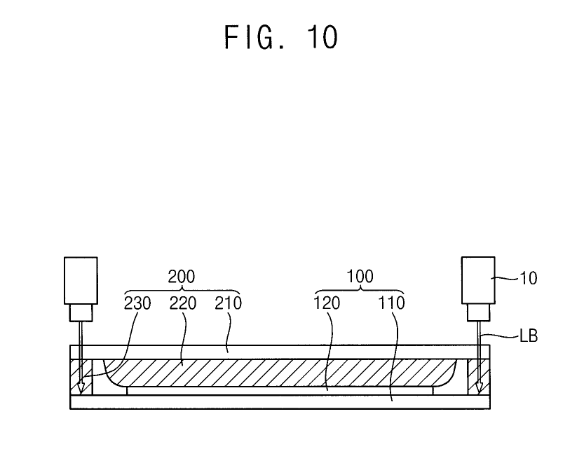

FIG. 9 is a cross-sectional view illustrating a process of combination between the exemplary embodiment of an organic light-emitting substrate part of FIG. 4 and the exemplary embodiment of a protective cover part of FIG. 5.

Referring to FIG. 9, when the organic light-emitting substrate part 100 and the protective cover part 200 are formed, the organic light-emitting substrate part 100 and the protective cover part 200 are aligned with each other such that the OLED display portion 120 is substantially covered by the cover frit glass 220.

Then, the organic light-emitting substrate part 100 and the protective cover part 200 are joined with each other. In one exemplary embodiment, the organic light-emitting substrate part 100 and the protective cover part 200 may be joined by vacuum compression. When the organic light-emitting substrate part 100 and the protective cover part 200 are vacuum compressed with each other, the cover frit glass 220 makes contact with the OLED display portion 120 to cover the OLED display portion 120, and the sealing frit glass 230 makes strong contact with the face of the base substrate 110.

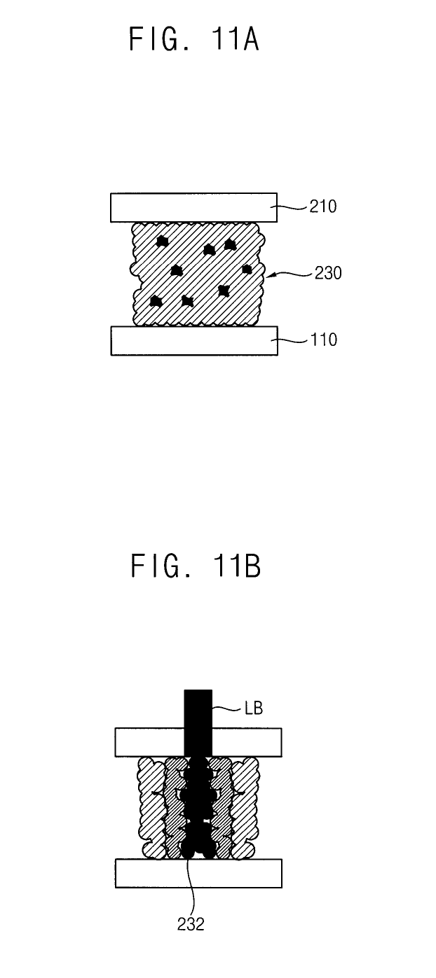

FIG. 10 is a cross-sectional view illustrating an exemplary embodiment of a process of applying a laser beam to the sealing frit glass, and FIGS. 11A and 11B are cross-sectional views illustrating states before and after applying a laser beam to the sealing frit glass.

Referring to FIGS. 10, 11A and 11B, a laser beam generating apparatus 10 is disposed over the sealing frit glass 230 and applies a laser beam LB toward the sealing frit glass 230. In one exemplary embodiment, the width of a portion 232 of the sealing frit glass 230, to which the laser beam LB is applied, may be about 60% to about 70% of the width of the sealing frit glass 230.

When the laser beam is applied to the sealing frit glass 230, the portion 232 of the sealing frit glass 230 is melted and thereafter hardened again to combine the base substrate 110 and the cover substrate 210 with each other. Therefore, the space between the base substrate 110 and the cover substrate 210 may be sealed by the sealing frit glass 230.

In one exemplary embodiment, the laser beam generating apparatus 10 may be a diode laser apparatus, which generates the laser beam LB. In one exemplary embodiment the wavelength of the laser beam LB is about 800 nm to about 820 nm. In one exemplary embodiment, the laser beam generating apparatus may generate the laser beam LB having a power level of about 50 W.

According to the present invention, a cover frit glass is formed such that the cover frit glass makes contact with an OLED display portion to cover the OLED display portion. Therefore, sagging of a cover substrate may be prevented to reduce the effects of impacts to the cover substrate on the OLED display portion. As a result, the OLED display portion may be protected by the cover substrate, so that the display quality of the OLED device may be enhanced.

Although exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. An organic light emitting diode display device comprising:
an organic light-emitting substrate part comprising:
a base substrate comprising a display region and a peripheral region substantially surrounding the display region; and
an organic light emitting diode display portion disposed in the display region; and
a protective cover part comprising
a cover substrate facing the base substrate;
a cover frit glass disposed on a face of the cover substrate and contacting and substantially covering the organic light emitting diode display portion; and
a sealing frit glass disposed on the face of the cover substrate in the peripheral region and combining the base substrate and the cover substrate with each other.

2. The organic light emitting diode device of claim 1, wherein the cover frit glass comprises a plurality of frit powder particles combined with each other.

3. The organic light emitting diode device of claim 2, wherein the cover frit glass is substantially porous.

4. The organic light emitting diode device of claim 1, wherein the sealing frit glass has a lower water reactivity than the cover frit glass.

5. The organic light emitting diode device of claim 4, wherein the sealing frit glass has a lower thermal expansion coefficient than the cover frit glass.

6. The organic light emitting diode device of claim 5, wherein the thermal expansion coefficient of the sealing frit glass is substantially the same as the thermal expansion coefficient of at least one of the cover substrate and the base substrate.

7. The organic light emitting diode device of claim 5, wherein the sealing frit glass comprises:
a plurality of frit powder particles combined with each other; and
a plurality of filler particles interposed between and combining the frit powder particles.

8. A method of manufacturing an organic light emitting diode display device, comprising:
providing an organic light-emitting substrate part comprising a base substrate having a display region and a peripheral region substantially surrounding the display region, and an organic light emitting diode display portion disposed in the display region;
providing a protective cover part comprising a cover substrate, a cover frit glass disposed on a face of the cover substrate, and a sealing frit glass disposed on the face of the cover substrate and substantially surrounding an outer edge of the cover frit glass; and
combining the organic light-emitting substrate part and the protective cover part with each other such that the cover frit glass makes contact with the organic light emitting diode display portion and covers the organic light emitting diode display portion.

9. The method of claim 8, wherein providing the protective cover part comprises:
disposing a cover frit paste having viscosity on the face of the cover substrate;
forming the cover frit glass through drying and firing of the cover frit paste;
disposing a sealing frit paste having viscosity on a face of the cover substrate and substantially surrounding an outer edge of the cover frit glass; and
forming the sealing frit glass through drying and firing the sealing frit paste.

10. The method of claim 9, wherein the cover frit paste comprises:
a plurality of frit powder particles;
a plurality of binder particles interposed between the frit powder particles; and
solvent which dissolves the frit powder particles and the binder particles.

11. The method of claim 10, wherein forming the cover frit glass comprises:
removing the solvent by drying the cover frit paste at a first temperature; and
firing the cover frit paste at a second temperature higher than the first temperature.

12. The method of claim 11, wherein the first temperature is in a range of about 180° C. to about 220° C., and
the second temperature is in a range of about 300° C. to about 600° C.

13. The method of claim 9, wherein the sealing frit paste comprises:
a plurality of frit powder particles;
a plurality of binder particles interposed between the frit powder particles;
a plurality of filler particles interposed between the frit powder particles; and
solvent which dissolves the frit powder particles, the binder particles and the filler particles.

14. The method of claim 13, wherein forming the sealing frit glass comprises:
removing the solvent by drying the sealing frit paste at a third temperature; and
firing the cover frit paste at a fourth temperature higher than the third temperature.

15. The method of claim 8, wherein providing the protective cover part comprises:
disposing a sealing frit paste having viscosity on the face of the cover substrate along edges of the cover substrate;
forming the sealing frit glass by drying and firing the sealing frit paste;
disposing a cover frit paste having viscosity on the face of the cover substrate within an area defined by the sealing frit glass; and
forming the cover frit glass by drying and firing the cover frit paste.

16. The method of claim 8, wherein forming the protective cover part, comprises:
disposing a cover frit paste and sealing frit paste having viscosity on the face of the cover substrate such that the sealing frit paste substantially surrounds the cover frit paste; and
forming the cover frit glass and the sealing frit glass by drying and firing the cover frit paste and the sealing frit paste.

17. The method of claim 8, wherein combining the organic light-emitting substrate part and the protective cover part, comprises:
aligning the organic light-emitting substrate part and the protective cover part with each other such that the cover frit glass contacts the organic light emitting diode display portion and covers the organic light emitting diode display portion; and
applying a laser beam to the sealing frit glass to combine the base substrate and the cover substrate with each other and to seal a space between the base substrate and the cover substrate.

18. The method of claim 17, wherein aligning the organic light-emitting substrate part and the protective cover part further comprises:
vacuum compressing the organic light-emitting substrate part and the protective cover part.

19. The method of claim 8, wherein the sealing frit glass has a lower water reactivity and a lower thermal expansion coefficient than the cover frit glass.

20. The method of claim 19, wherein a melting point of the cover frit glass is in a range of about 300° C. to 600° C., and
a melting point of the sealing frit glass is in a range of about 400° C. to about 500° C.
